(19) United States
(12) Patent Application Publication
(10) Pub. No.: US 2017/0121807 A1
(43) Pub. Date: May 4, 2017

(54) COATING METAL ONTO LITHIUM SECONDARY BATTERY ELECTRODE MATERIAL FOR ATMOSPHERIC PLASMA APPLICATION

(71) Applicants: Suxiang Deng, Shanghai (CN); GM GLOBAL TECHNOLOGY OPERATIONS LLC, DETROIT, MI (US)

(72) Inventors: Suxiang Deng, Shanghai (CN); Xiaohong Q. Gayden, West Bloomfield, MI (US); Qiang Wu, Shanghai (CN); Zhiqiang Yu, Shanghai (CN); Haijing Liu, Shanghai (CN); Dewen Kong, Shanghai (CN)

(21) Appl. No.: 15/129,886

(22) PCT Filed: Apr. 2, 2014
(86) PCT No.: PCT/CN2014/074596

§ 371 Date: Sep. 28, 2016

(51) Int. Cl. C23C 4/134; C23C 4/11; H01M 10/0525; H01M 4/1391; H01M 4/36; H01M 4/62; C23C 4/06; H01M 4/04

(52) U.S. Cl. CPC C23C 4/134; C23C 4/06; C23C 4/11; H01M 4/0404; H01M 4/0419; H01M 4/1391; H01M 4/366; H01M 4/626; H01M 10/0525; H01M 2220/20

(57) ABSTRACT

Layers of particles of positive or negative electrode materials for lithium-secondary cells are deposited on porous separator layers or current collector films using atmospheric plasma practices for the deposition of the electrode material particles. Before the deposition step, the non-metallic electrode material particles are coated with smaller particles of an elemental metal. The elemental metal is compatible with the particulate electrode material in the operation of the electrode and the metal particles are partially melted during the atmospheric deposition step to bond the electrode material particles to the substrate and to each other in a porous layer for infiltration with a liquid lithium ion-containing electrolyte. And the metal coating on the particles provides suitable electrical conductivity to the electrode layer during cell operation.

### TECHNICAL FIELD

This disclosure pertains to the use of an atmospheric plasma for forming thin layers of electrode materials on a cell-member surface in the manufacture of cell components for lithium secondary batteries. More specifically, this disclosure pertains to methods of coating particles of anode materials and cathode materials with smaller particles of elemental metal, preparatory to depositing the metal particle coated-electrode material particles on a current collector layer or a porous separator layer. During deposition of the particles of electrode material by atmospheric plasma, the metal particles melt to bond the electrode particles to each other and to a cell member substrate in a porous layer for infiltration by a liquid lithium-ion containing electrolyte in an assembled cell. The metal coating also provides electrical conductivity to the anode or cathode layer.

### BACKGROUND OF THE INVENTION

Assemblies of lithium-ion battery cells are finding increasing applications in providing motive power in automotive vehicles. Lithium-sulfur cells are also candidates for such applications. Each lithium-ion cell of the battery is capable of providing an electrical potential of about three to four volts and a direct electrical current based on the composition and mass of the electrode materials in the cell. The cell is capable of being discharged and re-charged over many cycles. A battery is assembled for an application by combining a suitable number of individual cells in a combination of electrical parallel and series connections to satisfy voltage and current requirements for a specified electric motor. In a lithium-ion battery application for an electrically powered vehicle, the assembled battery may, for example, comprise up to three hundred individually packaged cells that are electrically interconnected to provide forty to four hundred volts and sufficient electrical power to an electrical traction motor to drive a vehicle. The direct current produced by the battery may be converted into an alternating current for more efficient motor operation.

In these automotive applications, each lithium-ion cell typically comprises a negative electrode layer (anode, during cell discharge), a positive electrode layer (cathode, during cell discharge), a thin porous separator layer interposed in face-to-face contact between parallel facing electrode layers, and a liquid, lithium-containing, electrolyte solution filling the pores of the separator and contacting the facing surfaces of the electrode layers for transport of lithium ions during repeated cell discharging and re-charging cycles. Each electrode is prepared to contain a layer of an electrode material, typically deposited as a wet mixture on a thin layer of a metallic current collector.

For example, the negative electrode material has been formed by depositing a thin layer of graphite particles, often mixed with conductive carbon black, and a suitable polymeric binder onto one or both sides of a thin foil of copper which serves as the current collector for the negative electrode. The positive electrode also comprises a thin layer of resin-bonded, porous particulate, lithium-metal-oxide composition bonded to a thin foil of aluminum which serves as the current collector for the positive electrode. Thus, the respective electrodes have been made by dispersing mixtures of the respective binders and active particulate materials in a suitable liquid, depositing the wet mixture as a layer of controlled thickness on the surface of a current collector foil, and drying, pressing, and fixing the resin bonded electrode particles to their respective current collector surfaces. The positive and negative electrodes may be formed on conductive metal current collector sheets of a suitable area and shape, and cut (if necessary), folded, rolled, or otherwise shaped for assembly into lithium-ion cell containers with suitable porous separators and a liquid electrolyte. But such processing of the wet mixtures of electrode materials requires extended periods of manufacturing time. And the thickness of the respective active material layers (which limits the electrical capacity of the cell) is limited to minimize residual stress during drying of the electrode material.

The preparation and deposition of the wet mixtures of electrode materials on current collector foils is now seen as time-consuming, cell capacity limiting, and expensive. It is recognized that there is a need for a simpler and more efficient practice for making layers of electrode materials for lithium-ion battery cells.

In a related, commonly-owned, patent application, PCT (CN 2013) 085330, filed 16 Oct. 2013, titled “Making Lithium Secondary Battery Electrodes Using an Atmospheric Plasma,” methods were disclosed for making lithium secondary battery electrode structures using an atmospheric plasma to deposit particles of electrode materials onto a selected substrate surface for the electrode structure and to bond the deposited particles to the substrate surface of the electrode structure. When the electrode material was a conductive metal, such as aluminum or copper, used to from a current collector film for an electrode, particles of the conductive metal were deposited on a selected substrate using the disclosed atmospheric plasma process. And when the electrode materials were non-metallic particles for an active electrode material, such as silicon, graphite, or lithium titanate, the non-metallic material particles were preferably coated with a metal or mixed with metal particles prior to deposition on a cell member substrate using the atmospheric plasma.

### SUMMARY OF THE INVENTION

In accordance with practices of this invention, particles of non-metallic lithium-accepting and lithium-releasing materials for use in lithium-ion and lithium-sulfur electrode structures are coated with smaller particles of a suitable complementary conductive metal using an electroless coating or impregnation method. The conductive metal-coated, active electrode material particles are then deposited on a surface of a cell member using an atmospheric plasma source. Practices for applying submicron-size, elemental metal particles to small particles of non-metallic electrode material may be used to prepare the electrode particles in making anodes (negative electrodes) for lithium-ion cells and lithium-sulfur secondary cells, and they may be used in making cathodes (positive electrodes) for lithium-ion cells. The porous electrode structures are typically formed as thin layers of up to about two hundred micrometers in thickness. The metal particle-coated electrode particles are applied by using an atmospheric plasma to deposit a uniformly thick, porous layer of the particles, bonded to each other and to a porous ceramic or polymeric separator layer or to a metallic current collector layer.

In applications for making layered anode structures, the active material particles may, for example, be composed of one or more of silicon, silicon alloys, SiOx, Li—Si alloys, graphite, and lithium titanate (lithium meta-titanate, Li₂TiO₃). In accordance with practices of this invention, particles of non-metallic, active electrode material are prepared having a suitable particle size range for use in an electrode layer. For example, the non-metallic electrode material particles may have particle sizes in the range of about hundreds of nanometers to tens of micrometers, preferably in the range of about one micrometer to about fifty micrometers. Typically an elemental metal is applied in the form of sub-micron size particles on the surfaces of the particles of active electrode material. The coating of smaller metal particles, dispersed on the particles of active material, is to serve as a binder, by providing binding sites, and to provide suitable electrical conductivity in a layer of electrode material deposited in a substrate by atmospheric plasma application. The composition of the metal binder and electrical conductor is selected to be compatible with the electrochemical working potentials of the cathode or anode of a lithium secondary battery. In general, metals suitable as binder/conductors in lithium-ion anode electrodes include: copper, silver, and gold (Group 1B of the periodic table), nickel, palladium, and platinum (Group VIII), and tin (Group IVA). The composition of the conductive metal is selected and used in an amount to partially melt in the atmospheric plasma and to bond the electrode material particles as a porous layer to a current collector foil for lithium-secondary cell or to a porous separator layer for the cell. Upon re-solidification, the conductive metal provides binding sites that bond the electrode material particles to each other in a porous layer and to an underlying current collector or separator substrate. The conductive metal constituent is used in an amount to securely bond the active electrode material particles to the cell-member substrate as a porous layer that can be infiltrated with a liquid electrolyte to be used in an assembled lithium-ion cell. Further, the conductive metal also provides electrical conductivity to the deposited layer of electrode material. Typically, the particles of conductive metal may be applied in an amount of from about five weight percent to about sixty weight percent of the total weight of the composite of metal and active material constituent(s). In accordance with practices of this invention, the conductive metal/active electrode material particle composition consists exclusively of such metal particle site bound-active material for the electrode, free of any liquid vehicle or organic binder material.

Similarly, and separately, particles of positive electrode materials, such as lithium-manganese-oxide, lithium-nickel-oxide, and/or lithium-cobalt-oxide are coated with metal particles by an electroless coating or impregnation method. Metals suitable as particle-site binder/conductors in lithium-ion cathode electrodes include: aluminum, indium, and thallium (Group IIIA), titanium, zirconium, and hafnium (Group IVB), nickel, palladium, and platinum (Group VIII), and silver and gold (Group IB). Preferably, sub-micron-size particles of the selected metal are deposited on particles of the non-metallic active electrode material by an electroless coating or impregnation method.

In one exemplary electroless deposition process for the formation of lithium-ion cell anode material, an aqueous solution of a metal salt (such as copper sulfate or copper nitrate) is combined with a cation complex-forming agent such as ethylene diamine tetraacetic acid (EDTA). The complex is de-stabilized and chemically reduced to deposit submicron size elemental copper particles on particles of a selected anode material such as lithium titanate.

In another suitable electroless impregnation method, a solution is prepared of a suitable metal salt (such as a solution of copper nitrate in ethanol). Particles of active electrode materials are wetted with the solution to coat each particle of electrode material. Particles of metal salt are deposited on the particles of the active electrode material by evaporation of the solvent (e.g., ethanol). The metal salt coated electrode material particles are annealed in air to form metal oxide particles. And the metal oxide particles are reduced in hydrogen to form active material particles coated with sub-micron sized elemental metal particles.

Electrode material/conductor particles of suitable micron-size are then supplied or delivered (for example) by gravity into a gas stream, such as an air stream or a stream of nitrogen or an inert gas, flowing within an upstream tubular delivery tube of an atmospheric plasma generator. The particles are preferably delivered through a powder management device to ensure stable and consistent delivery of the electrode material/conductor particles into the gas stream. As stated, the particles may consist, for example, of copper-coated, silicon-containing particles for forming an anode layer for a lithium-ion cell. The two-component particles are dispersed into the gas stream and carried into the nozzle of the plasma generator where the flowing gas molecules are momentarily converted into plasma by a suitable electrical discharge at the nozzle outlet. The plasma heats the moving dispersed particles to soften and partially melt the coating of metallic, electrical conductor particles. For example, sites of small droplets of molten metal are formed on the surfaces of the electrode material particles. As the particle mixture is deposited on the surface of an unheated substrate, the liquefied metal coating sites re-solidify to bond the active electrode material particles to each other in a porous layer and the metal bonds the particles at the facing surface of the particulate layer to the substrate surface.

The atmospheric plasma stream is directed against the substrate surface in, for example, a suitable sweeping path so as to deposit the active electrode material as a porous layer of conductive metal-bonded particles adhering to the cooperating metal foil substrate. Either, or both, of the plasma and substrate may be in motion during the deposition of the active electrode material. In many applications of the process, the electrode material layer will be deposited in one or more coating steps with a total uniform thickness of up to about 200 micrometers. The thickness of the deposit of active electrode material usually depends on the intended electrical generating capacity of the cell.

The electrodes function upon suitable contact of the electrode material by the electrolyte and transfer of lithium into and from each electrode during the cycling of the cell.

In general, atmospheric plasma deposition practices of the invention may be conducted under ambient conditions and without preheating of either the substrate layer or the solid particles carefully supplied to the atmospheric plasma generator.

Although the coating particles are momentarily heated in the high temperature atmospheric plasma, they are typically deposited on the substrate material without heating the substrate to a temperature as high as 150° C.

Other objects and advantages of the invention will become apparent from the further illustrations of practices of the invention in the following sections of this specification.

### BRIEF DESCRIPTION OF THE DRAWINGS

FIG. 1 is an enlarged schematic illustration of the anode, separator, and cathode elements of a lithium-ion cell depicting an anode and a cathode, each consisting of a metal current collector carrying a porous layer of deposited conductive metal/active electrode material formed in accordance the atmospheric plasma deposition process of this invention.

FIGS. 2(a)-2(d) present a schematic flow diagram illustration of a process for coating particles of active electrode material with particles of metal using an impregnation method. FIG. 2(a) depicts a bare particle of active material, such as lithium titanate, for a lithium cell electrode. In step 2(b) the active material particle is coated with a layer of metal salt (such as copper sulfate or copper nitrate). In step 2(c) the coated particle has been annealed in air to produce particles of metal oxide (e.g., CuO). And in step 2(d), the metal oxide has been reduced with hydrogen gas to produce elemental particles of the metal (e.g., Cu) on the particle of lithium titanate, or other active electrode material.

FIG. 3A is a microscopic image, at 50,000-fold magnification, of particles of bare lithium titanate. The circled area in 3A focuses attention on a grouping of small particles of lithium titanate. The particles of lithium titanate are seen to be of irregular shapes. In this example, the primary particles of lithium titanate are quite small, of the irregularly-shaped particles of lithium titanate are quite small, up to about two micrometers in largest dimension. In practices of this invention, such primary particles may be sintered or annealed to form larger particles, up to about fifty microns in largest dimension.

FIG. 3B is a microscopic image, at 100,000-fold magnification, of particles of lithium titanate coated with particles of elemental copper. Again, the circle focuses attention at a representative location. Under the incident radiation of the image, the lithium titanate particles and copper particles display a like appearance. At such high magnification, with limited survey area, the sub-micron size copper particles appear to be deposited in an irregular pattern on the lithium titanate particles. At smaller magnification, the copper particles are seen as substantially evenly coated on the surfaces of the particles of electrode material. The largest dimensions of the metal particles coated onto the active electrode material particles are typically sub-micron.

FIG. 4 is a schematic illustration depicting a powder delivery system and atmospheric plasma nozzle applying one or more layers of conductive metal particle-coated active electrode material particles to a metallic current collector foil. A like practice may be used for applying one or more layers of conductive metal/active electrode material to a porous separator layer.

### DESCRIPTION OF PREFERRED EMBODIMENTS

An active lithium-ion cell material is an element or compound which accepts or intercalates lithium ions, or releases or gives up lithium ions in the discharging and re-charging cycling of the cell. A few examples of suitable electrode materials for the anode (or negative electrode) of a lithium ion cell are graphite, silicon, alloys of silicon with lithium or tin, silicon oxides (SiOx), and lithium titanate. Examples of cathode (or positive electrode) materials include lithium manganese oxide, lithium nickel oxide, lithium cobalt oxide and other lithium-metal-oxides. Other materials are known and commercially available. One or more of these materials may be used in an electrode layer. In accordance with practices of this invention, as will be described in more detail below in this specification, the respective electrode materials are initially in the form of micron size particles (e.g., about one to about fifty microns in largest dimension) that are coated by an electroless coating or impregnation method with smaller particles of electrically conductive, elemental metal. For example, copper particles up to about five micrometers in maximum dimension have been deposited by an electroless coating or impregnation method on lithium titanate particles up to about fifty micrometers in largest dimension.

An illustrative lithium-ion cell will be described, in which electrode members can be prepared using practices of this invention.

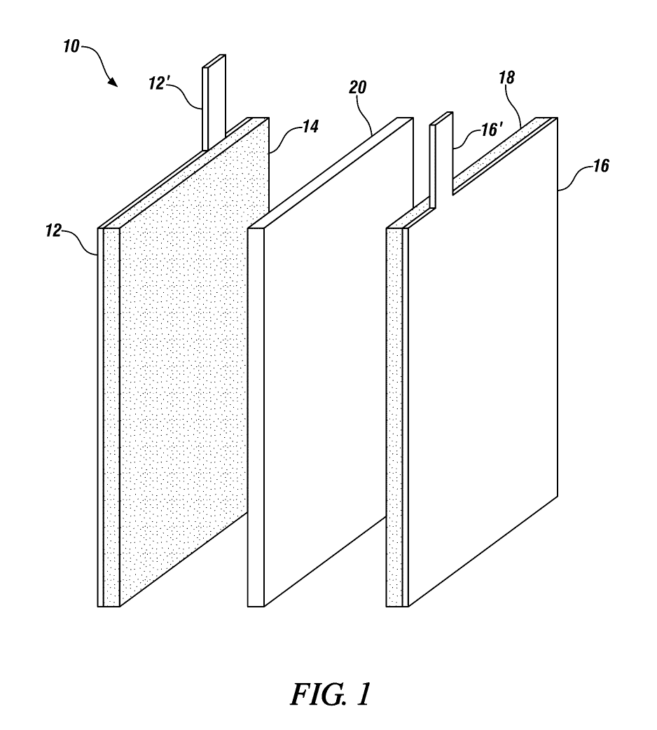

FIG. 1 is an enlarged schematic illustration of a spaced-apart assembly 10 of three solid members of a lithium-ion electrochemical cell. The three solid members are spaced apart in this illustration to better show their structure. The illustration does not include an electrolyte solution whose composition and function will be described in more detail below in this specification. Practices of this invention are typically used to manufacture electrode members of the lithium-ion cell when they are used in the form of relatively thin, layered structures.

In FIG. 1, a negative electrode comprises a relatively thin conductive metal foil current collector 12. In many lithium-ion cells, the negative electrode current collector 12 is suitably formed of a thin layer of copper. The thickness of metal foil current collector is suitably in the range of about ten to twenty-five micrometers. The current collector 12 has a desired two-dimensional plan-view shape for assembly with other solid members of a cell. Current collector 12 is illustrated as rectangular over its principal surface, and further provided with a connector tab 12′ for connection with other electrodes in a grouping of lithium-ion cells to provide a desired electrical potential or electrical current flow.

Deposited on the negative electrode current collector 12 is a thin, porous layer of negative electrode material 14. As illustrated in FIG. 1, the layer of negative electrode material 14 is typically co-extensive in shape and area with the main surface of its current collector 12. The electrode material has sufficient porosity to be infiltrated by a liquid, lithium-ion containing electrolyte. The thickness of the rectangular layer of negative electrode material may be up to about two hundred micrometers so as to provide a desired current and power capacity for the negative electrode. As will be further described, the negative electrode material may be applied layer-by-layer so that one large face of the final block layer of negative electrode material 14 is bonded to a major face of current collector 12 and the other large face of the negative electrode material layer 14 faces outwardly from its current collector 12. In accordance with practices of this invention, the negative electrode material (or anode during cell discharge) is formed by using an atmospheric plasma deposition method to deposit metal particle-coated anode material on a metallic current collector foil substrate. Methods for the preparation of the metal particle-coated anode material are presented below in this specification.

A positive electrode is shown, comprising a positive current collector foil 16 (often formed of aluminum) and a coextensive, overlying, porous deposit of positive electrode material 18. Positive current collector foil 16 also has a connector tab 16′ for electrical connection with other electrodes in other cells that may be packaged together in the assembly of a lithium-ion battery. The positive current collector foil 16 and its coating of porous positive electrode material 18 are typically formed in a size and shape that are complementary to the dimensions of an associated negative electrode. In the illustration of FIG. 1, the two electrodes are alike (but they do not have to be identical) in their shapes, and assembled in a lithium-ion cell with the major outer surface of the negative electrode material 14 facing the major outer surface of the positive electrode material 18. The thicknesses of the rectangular positive current collector foil 16 and the rectangular layer of positive electrode material 18 are typically determined to complement the negative electrode material 14 in producing the intended electrochemical capacity of the lithium-ion cell. The thicknesses of current collector foils are typically in the range of about 10 to 25 micrometers. And the thicknesses of the electrode materials, formed by this dry atmospheric plasma process are up to about 200 micrometers. Again, in accordance with practices of this invention, the positive electrode material (or cathode during cell discharge) is formed by using an atmospheric plasma deposition method to deposit metal particle-coated cathode material on a metallic current collector foil substrate.

A thin porous separator layer 20 is interposed between the major outer face of the negative electrode material layer 14 and the major outer face of the positive electrode material layer 18. In many battery constructions, the separator material is a porous layer of a polyolefin, such as polyethylene or polypropylene. Often the thermoplastic material comprises inter-bonded, randomly oriented fibers of PE or PP. The fiber surfaces of the separator may be coated with particles of alumina, or other insulator material, to enhance the electrical resistance of the separator, while retaining the porosity of the separator layer for infiltration with liquid electrolyte and transport of lithium ions between the cell electrodes. The separator layer 20 is used to prevent direct electrical contact between the negative and positive electrode material layers 14, 18, and is shaped and sized to serve this function. In the assembly of the cell, the opposing major outer faces of the electrode material layers 14, 18 are pressed against the major area faces of the separator membrane 20. A liquid electrolyte is injected into the pores of the separator membrane 20 and electrode material layers 14, 18.

The electrolyte for the lithium-ion cell is often a lithium salt dissolved in one or more organic liquid solvents. Examples of salts include lithium hexafluorophosphate (LiPF₆), lithium tetrafluoroborate (LiBF₄), lithium perchlorate (LiClO₄), lithium hexafluoroarsenate (LiAsF₆), and lithium trifluoroethanesulfonimide. Some examples of solvents that may be used to dissolve the electrolyte salt include ethylene carbonate, dimethyl carbonate, methylethyl carbonate, propylene carbonate. There are other lithium salts that may be used and other solvents. But a combination of lithium salt and liquid solvent is selected for providing suitable mobility and transport of lithium ions in the operation of the cell. The electrolyte is carefully dispersed into and between closely spaced layers of the electrode elements and separator layers. The electrolyte is not illustrated in the drawing figure because it is difficult to illustrate between tightly compacted electrode layers.

In accordance with embodiments of this invention, atmospheric plasmas are used in the manufacture of electrode members of lithium-ion cells. And in accordance with practices of this invention, particles of an active electrode material are coated with smaller particles of a suitable complementary elemental metal (or mixtures of elemental metals) for use in the atmospheric plasma deposition process. For example, anode materials may be prepared for use in lithium-ion cells and lithium-sulfur cells by coating practices of this invention. And cathode materials may be prepared for lithium-ion cells.

As described above in this specification, anodes for lithium-ion cells are often made by placement of a porous lithium titanate material on a copper foil current collector. And cathodes for lithium-ion cells are often made by placement of a porous lithium cobalt oxide layer on an aluminum foil current collector. In accordance with this invention, particles of lithium titanate are coated with smaller particles of copper and the copper-coated lithium titanate particles are applied to a surface of a copper current collector or to a surface of a porous separator. In a similar manner, particles of lithium cobalt oxide are coated with particles of aluminum and applied to a surface of an aluminum current collector or to a surface of a porous separator.

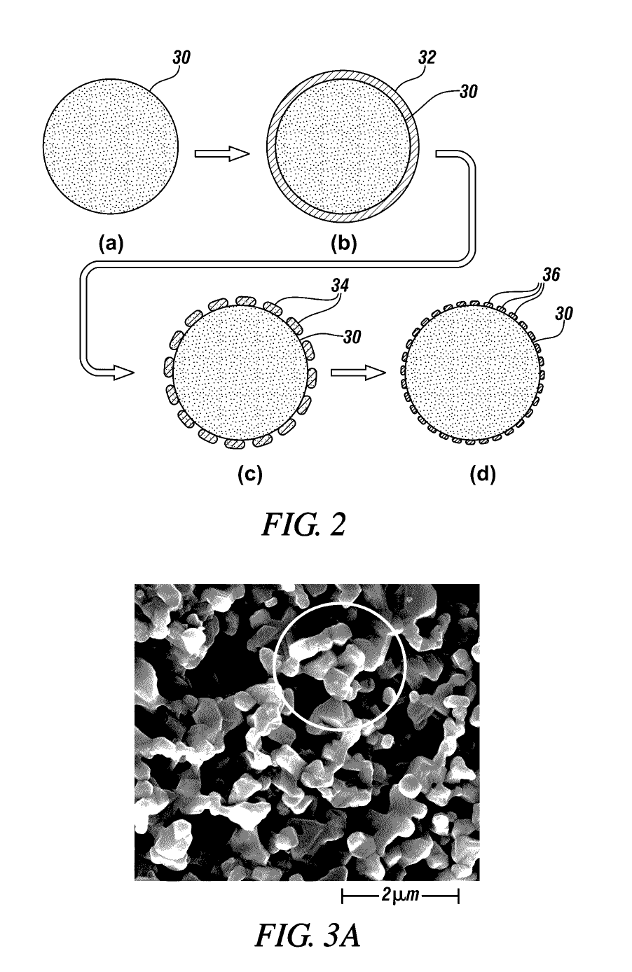

FIGS. 2(a)-2(d) illustrate schematically an impregnation-deposition process that may be used to coat small particles of an electrode material with smaller particles of an elemental metal preparatory to deposition on an electrode substrate by atmospheric plasma. In FIGS. 2(a)-2(d) the coating of a single particle is depicted, but it is to be understood that a predetermined quantity of electrode particles would be coated as a batch process preparatory for making, e.g., an anode or a group of anodes for a lithium-ion cells. This coating process is suitable for general application to deposit any of a number of elemental metals on any of a number of electrode material particles.

In this example, the method is applied to deposit copper particles on particles of lithium titanate. In FIG. 2(a) a single bare particle 30 of lithium titanate is depicted schematically as a generally spherical particle. The lithium titanate particles may be of irregular shape with a largest or representative dimension in the range of about two to fifty micrometers. An ethanol solution of copper nitrate was prepared for the soaking of a batch of the lithium titanate particles so as to wet each lithium titanate particle with solution of the copper salt.

In this example, Cu(NO₃)₂.3H₂O was dissolved in pure ethanol to form a solution containing two moles per liter of copper. The solution of copper salt was soaked onto a porous mass of the electrode particles in a suitable container, and the alcohol is evaporated at ambient temperature to leave a coating of 1.18 grams of the copper salt, Cu(NO₃)₂, 32 in FIG. 2(a), on each gram of the particles of lithium titanate 30. In accordance with the following steps, the copper salt was converted to 0.4 grams of elemental copper per gram of lithium titanate particles. In this example, the copper ratio in the Cu/lithium titanate composite particle mixture was 28.6 weight percent. Suitable proportions of copper in Cu/lithium titanate composites, for example, range from about five to about sixty weight percent.

The above-described copper nitrate-coated lithium titanate particles were initially heated in air from room temperature to 150° C. at a rate of 5 C/minute. The mixed particles were then heated in air from 150° C. to 400° C. at a rate of 1 C/min. The mixed particles were held in air for five hours at 400° C., and then air cooled to room temperature. The copper nitrate deposit on the lithium titanate particles 30 was thus converted to particles 36 of copper oxide (CuO) on lithium titanate particle 30 in FIG. 2(c).)

The copper oxide particles 36 on the lithium titanate particle 30 were reduced in a hydrogen atmosphere, as follows, to form lithium titanate particles 30 coated with sub-micron sized elemental copper particles 36 as illustrated in FIG. 2(d). The CuO-coated lithium titanate particles were heated under a hydrogen (5 volume %)-argon gas mixture from room temperature to 300° C. at a rate of 5 C/minute and then heated under the same atmosphere to 400° C. at a rate of 2 C/min. The CuO-coated lithium titanate particles mixture was retained under the hydrogen-argon mixture at 400° C. for four hours and then allowed to cool under the hydrogen-argon mixture to room temperature. The solid mixture was examined and found to consist of copper particles coated and dispersed on particles of lithium titanate.

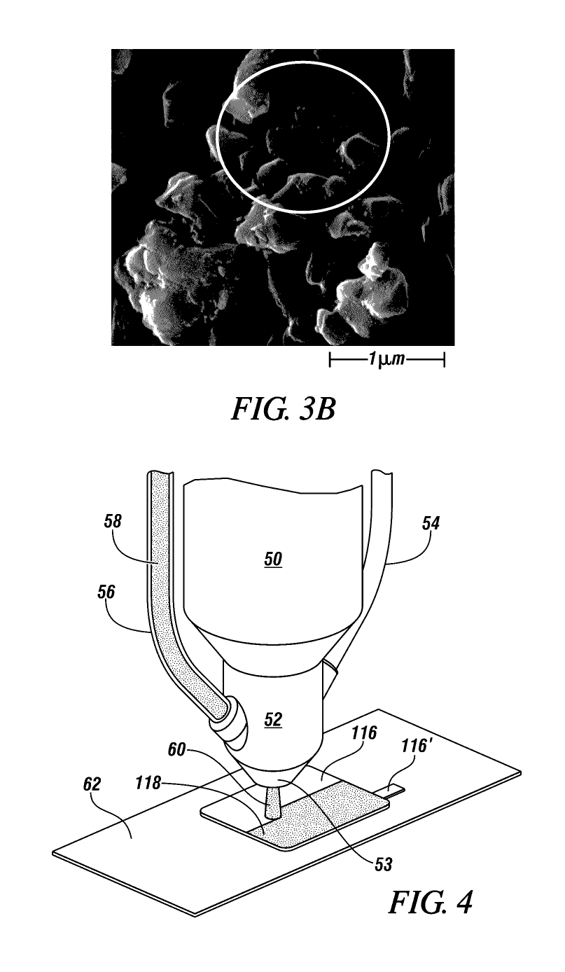

The illustration of FIG. 2(d) is idealized for illustration. The copper particles are shown as being generally uniformly distributed on a circular cross-section of a spherical particle. FIG. 3B illustrates (at 100,000-fold magnification) actual particles of lithium titanate coated with particles of copper by the process described with reference to FIGS. 2(a)-2(d).

FIG. 3A is a microscopic image, at 50,000-fold magnification, of particles of bare lithium titanate. The small particles of lithium titanate are seen to be of irregular shapes. FIG. 3B is a microscopic image, at 100,000-fold magnification, of particles of lithium titanate coated with particles of elemental copper. At 100,000-fold magnification, the morphology of the copper particles seems to be in an irregular pattern, but in lower magnification, the copper coating is seen as quite uniform on the surfaces of the lithium titanate or other active material particles.

In general, a suitable, electrochemically compatible conductive elemental metal is selected for deposition on the surfaces of suitably-sized particles of active lithium-ion electrode material. An inorganic or organic compound of the metal and a solvent are selected for soaking and dispersing the metal compound onto the particles of the active electrode material. In general, a metal salt which can readily be converted into the metal oxide is preferred. And a solvent is selected which will dissolve an appreciable amount of the metal compound for obtaining a suitable amount of the metal compound on the particles of active material. After removing the solvent to deposit the selected metal compound on the active material particles, the metal is oxidized by a suitable oxidation process, analogous to that described for the copper nitrate. Then the metal oxide is reduced with hydrogen to leave small particles of the conductive elemental metal on the surfaces of the particles of active electrode material.

In another exemplary electroless deposition process for the formation of lithium-ion cell anode material, an aqueous solution of a metal salt (such as cupric sulfate) is combined with a cation complex-forming agent such as ethylene diamine tetraacetic acid (EDTA). The complex is de-stabilized in the presence of a suitable reducing agent to deposit submicron size elemental copper particles on particles of a selected anode material, such as lithium titanate. For example, an aqueous solution of 0.04 M CuSO₄ and 0.04M EDTA is prepared and mixed with an amount of lithium titanate to obtain a desired amount of coating with copper particles. Sodium hydroxide is added to the aqueous solution to achieve a pH of 12 and the mixture is heated to about 70° C. An aqueous formaldehyde solution (8 mmol) or the equivalent amount of solid paraformaldehyde is added to the aqueous dispersion with lithium titanate particles. The liquid-solid system is purged with a stream of nitrogen. After the addition of the formaldehyde reductant and the nitrogen streaming for about three to five hours, the lithium titanate particles, now coated with copper particles were collected by filtration, washed with an abundance of water and dried. The resultant solid mixture is elemental copper particle-coated lithium titanate particles.

Other chelating agents for the deposition of elemental metals on particles of active electrode particles include sodium citrate, Quadrol® [N,N,N′,N′-tetrakis (2-hydroxypropyl) ethylenediamine], Rochelle salts (potassium sodium tartrate), and EDTA with an alkanolamine, particularly triethanolamine. In addition to formaldehyde, suitable reducing agents for use with the chelate agent-complexed metal salt are hypophosphite, borohydride, hydrazine, glyoxalic acid, and amine-boranes. Many metals may be electroless coated by such complexation of a salt and reduced. They include, for example, copper, nickel, tin, and gold.

In an exemplary electroless coating or impregnation method for the formation of lithium-ion cell cathode material, a metal salt, such as aluminum chloride, is dissolved in an ionic liquid such as 1-ethyl-3-methylimidizolium chloride (EMIC). The solution is destabilized in the presence of a suitable reducing agent to deposit submicron size elemental aluminum particles on particles of a selected cathode material, such as lithium manganese oxide (LMO). For example, 0.04 mol of AlCl₃ and 0.02 mol of EMIC were mixed by stirring. An aluminum wire was then immersed in the liquid for a period of time (e.g., a period of 168 hours) to purify the liquid and to obtain a colorless and transparent ionic liquid. The ionic liquid was then mixed with an amount of lithium manganese oxide particles to obtain a coating of submicron-sized aluminum particles on the cathode material particles. Diisobutyl aluminum hydride (DIBAH), a reducing agent, was added, with a stream of flowing argon, to the mixture of aluminum-containing ionic liquid and small LMO particles. After a reaction period of about three to five hours, the LMO particles, now coated with submicron aluminum particles, are collected by filtration, washed with ethanol, and dried. The resultant material is lithium manganese oxide particles coated with submicron particles of elemental aluminum. The mixture may be deposited using an atmospheric plasma on a lithium-ion battery substrate layer, such as a cathode current collector foil or a battery separator layer.

Other ionic liquids to dissolve an aluminum salt (e.g., AlCl₃) include 1-alkyl-3-methylimidazolium chlorides such as 1-butyl-3-methylimidazolium chloride (BMIC), and alkyl pyridinium chlorides such as n-butyl pyridinium chloride (BPC). Other suitable reducing agents include LiH, LiAlH₄, and NaBH₄.

Elemental metal particle-coated electrode material particles are thus ready for deposition on a lithium cell substrate member in a battery electrode-making process using an atmospheric plasma source. In many practices, the metal-coated electrode material is deposited on a current collector substrate using atmospheric plasma. The resulting electrode may then be stacked with a separator member and combined with an opposing electrode member, made using a complementary metal coated electrode material. In another practice, metal particle coated electrode material particles may be deposited on a porous separator member using atmospheric plasma. And a layer of current collector material may be deposited to the upper side of the deposited electrode material.

The total coating thickness can reach up to a few hundred microns depending on the electrode materials used and plasma processing conditions. Its wide thickness range makes the process versatile for both energy and power cell applications. In contrast to the current wet-transfer coating method of making battery electrodes, by eliminating the need for slurry, wet coating, drying and pressing processes, cell manufacturing cycle time and cost can be greatly reduced.

Atmospheric plasma spray methods are known and plasma spray nozzles are commercially available. In practices of this invention, and with reference to FIG. 4, an atmospheric plasma apparatus may comprise an upstream round flow chamber (shown in partly broken-off illustration at 50 in FIG. 4) for the introduction and conduct of a flowing stream of suitable working gas, such as air, nitrogen, or an inert gas such as helium or argon. In this embodiment, this illustrative initial flow chamber 50 is tapered inwardly to smaller round flow chamber 52. Particles of metal particle-coated electrode materials 58 are delivered through supply tubes 54, 56 (tube 56 is shown partially broken-away to illustrate delivery of the two-component particles 58) and are suitably introduced into the working gas stream in chamber 52 and then carried into a plasma nozzle 53 in which the air (or other working gas) is converted to a plasma stream at atmospheric pressure. And, for example, particles of a first metal particle-coated active material composition or morphology may be delivered through one supply tube 54 and particles of a second metal particle-coated active material or morphology delivered through a second supply tube 56. As the particles 58 enter the gas stream they are dispersed and mixed in it and carried by it. As the stream flows through a downstream plasma-generator nozzle 53, the particles 58 are heated by the formed plasma to a deposition temperature. The momentary thermal impact on the particles may be a temperature up to about 3500° C. As stated above in this specification, the metal component of the active electrode material particles is at least partially and momentarily melted in the plasma.

The stream of air-based plasma and suspended electrode particle material 60 is progressively directed by the nozzle against the surface of a substrate, such as a metal current collector foil 116 for a positive electrode for a lithium-ion cell. The substrate foil 116 is supported on a suitable working surface 62 for the atmospheric plasma deposition process. The deposition substrate for the atmospheric plasma deposition is illustrated in FIG. 4 as an individual current collector foil 116 with its connector tab 116′. But it is to be understood that the substrate for the atmospheric plasma deposition may be of any size and shape for economic use and application of the plasma. It is also to be understood that suitable fixtures may be required to secure the substrate in place and/or a mask may be required to define the coated area or areas. And further, for example, specified smaller working electrode members may later be cut from a larger initially coated substrate. The nozzle is moved in a suitable path and at a suitable rate such that the particulate electrode material is deposited as a layer of positive electrode material 118 of specified thickness on the surface of the current collector foil 116 substrate. The plasma nozzle may be carried on a robot arm and the control of plasma generation and the movement of the robot arm be managed under control of a programmed computer. In other embodiments of the invention, the substrate is moved while the plasma is stationary.

In embodiments of this invention, the two-component particulate material (58 in FIG. 2) to be deposited by the plasma nozzle and process comprises a minor portion of relatively low melting conductive metal, such as aluminum, which is intended to be partially melted in the plasma stream so as to serve as a conductive binder for the lithium compounds that are typically used to make-up the positive electrode material.

Such plasma nozzles for this application are commercially available and may be carried and used on robot arms, under multi-directional computer control, to coat the many surfaces of each planar substrate for a lithium-ion cell module. Multiple nozzles may be required and arranged in such a way that a high coating speed may be achieved in terms coated area per unit of time.

The plasma nozzle typically has a metallic tubular housing which provides a flow path of suitable length for receiving the flow of working gas and dispersed particles of electrode material and for enabling the formation of the plasma stream in an electromagnetic field established within the flow path of the tubular housing. The tubular housing terminates in a conically tapered outlet, shaped to direct the shaped plasma stream toward an intended substrate to be coated. An electrically insulating ceramic tube is typically inserted at the inlet of the tubular housing such that it extends along a portion of the flow passage. A stream of a working gas, such as air, and carrying dispersed particles of metal particle-coated electrode material, is introduced into the inlet of the nozzle. The flow of the air-particle mixture may be caused to swirl turbulently in its flow path by use of a swirl piece with flow openings, also inserted near the inlet end of the nozzle. A linear (pin-like) electrode is placed at the ceramic tube site, along the flow axis of the nozzle at the upstream end of the flow tube. During plasma generation the electrode is powered by a high frequency generator at a frequency of about 50 to 60 kHz (for example) and to a suitable potential of a few kilovolts. The metallic housing of the plasma nozzle is grounded. Thus, an electrical discharge can be generated between the axial pin electrode and the housing.

When the generator voltage is applied, the frequency of the applied voltage and the dielectric properties of the ceramic tube produce a corona discharge at the stream inlet and the electrode. As a result of the corona discharge, an arc discharge from the electrode tip to the housing is formed. This arc discharge is carried by the turbulent flow of the air/particulate electrode material stream to the outlet of the nozzle. A reactive plasma of the air and electrode material mixture is formed at a relatively low temperature. A copper nozzle at the outlet of the plasma container is shaped to direct the plasma stream in a suitably confined path against the surfaces of the substrates for the lithium-ion cell elements. And the plasma nozzle may be carried by a computer-controlled robot to move the plasma stream in multi-directional paths over the planar surface of the substrate material to deposit the electrode material in a continuous thin layer on the thin substrate surface layer. The deposited plasma-activated material forms an adherent porous layer of bonded electrode material particles on the current collector foil surface.

In the example illustrated in FIG. 4, a positive electrode material, such as particles of LiMnO₂ coated with a thin layer of aluminum particles is illustrated as being deposited by atmospheric plasma on an aluminum current collector foil. The combination of metallic current collector and plasma deposited positive electrode material thus illustrate the making of individual positive electrodes for a lithium-ion cell. Negative electrodes may be made in a like manner with negative electrode material (containing a coating of copper particles) being deposited using the plasma on a negative electrode current collector. As stated, the plasma process may be used to make individual layered electrodes or a large sheet of such electrodes from which individual electrodes may be cut or formed.

Also, two different active materials (varying in composition and/or morphology) may be co-deposited, one from each of two or more different delivering tubes supplying the plasma nozzle. This provides flexibility to the electrode material forming process by changing electrode material compositions from one layer to another in the plasma delivery process to change electrode properties in different layers of a multi-layer deposit on a substrate.

As stated, a suitable non-electrically conductive, porous separator layer may be used as a substrate. The atmospheric plasma coating deposit does not get so hot as to damage a polymeric separator if one is used as a substrate. Electrode materials may be deposited on the separator membrane substrate in a suitable pattern. And a current collector layer may be deposited by atmospheric plasma in a suitable pattern on the electrode material layer.

Thus, methods of using atmospheric plasma have been provided to form layered electrode materials and current collectors for working electrodes and reference electrodes in lithium-ion cells. The plasma method enables the formation of working material layers of up to about two hundred micrometers in thickness to increase the capacity of the electrodes. And the process avoids the use of extraneous binders of polymers and the need for wet process application of electrode materials to their current collector substrates.

It is recognized that the use of an atmospheric plasma may also be utilized in forming anode materials for lithiated silicon-sulfur secondary batteries. Lithiated silicon-sulfur cells typically comprise a lithiated silicon-based anode, a lithium polysulfide electrolyte, a porous separator layer and a sulfur-based cathode. A layer of silicon based materials, including, for example, silicon, silicon alloys, and silicon-graphite composites, up to about 200 microns in thickness is deposited on a metal current collector in the formation of an anode layer. Atmospheric plasma deposition processes, like those described for the preparation of layered electrode members of lithium-ion cells may be used in making analogous electrode structures for lithiated silicon-sulfur cells.

The examples that have been provided to illustrate practices of the invention are not intended as limitations on the scope of such practices.

1. A method of forming electrode material for a lithium secondary cell comprising:
providing non-metallic particles of an anode electrode material or of a cathode electrode material for a lithium secondary cell, the particles having largest dimensions in the range of about one to about fifty micrometers;
forming a predetermined weight of particles of an elemental metal on the surfaces of the non-metallic particles of electrode material by applying a compound of the metal on the surfaces of the particles of electrode material and chemically reducing the metal compound to particles of the elemental metal; and, thereafter
inserting the metal particle-coated electrode material particles into an atmospheric plasma stream to direct and deposit the metal particle-coated electrode material particles in a continuous layer on a cell substrate layer which is a structural member of a lithium secondary cell, the substrate layer being a porous separator layer or a metallic current collector layer, the thickness of the deposited layer of particles being up to about 200 micrometers and the temperature produced in the deposited particles by the atmospheric plasma causing sufficient momentary melting of the metal particles to provide metal coating sites on the surfaces of the electrode material particles that bond the non-metallic particles of the electrode materials to each other and to the substrate layer in a porous layer of electrode material, the metal coating sites also providing electrical conductivity in the deposited layer of porous electrode material.

2. A method of forming electrode material as recited in claim 1 in which the weight of the elemental metal particles formed on the surfaces of the particles of electrode material is greater than about five weight percent of the total weight of the particles of electrode material and the deposited elemental metal particles.

3. A method of forming an electrode material as recited in claim 1 in which the weight of the elemental metal particles formed on the surfaces of the particles of electrode material is in the range of from about five weight percent to about sixty weight percent of the total weight of the particles of electrode material and the deposited elemental metal particles.

4. A method of forming an electrode material as recited in claim 1 in which the electrode material particles are for the anode for a lithium-ion cell or for a lithium-sulfur cell and comprise one or more compositions selected from the group consisting of silicon, silicon alloys, SiOx, a lithium-silicon alloy, graphite, and lithium titanate.

5. A method of forming an electrode material as recited in claim 4 in which the particles of elemental metal deposited on the anode material particles are a metal selected from the group consisting of copper, silver, gold, nickel, palladium, platinum, and tin.

6. A method of forming an electrode material as recited in claim 1 in which the electrode material particles are for a cathode for a lithium-ion cell and comprise one or more compositions selected from the group consisting of lithium-manganese-oxide particles, lithium-nickel-oxide particles, and lithium-cobalt oxide particles.

7. A method of forming an electrode material as recited in claim 6 in which the particles of elemental metal deposited on the cathode material particles are a metal selected from the group consisting of aluminum, indium, thallium, titanium, zirconium, hafnium, nickel, palladium, platinum, silver, and gold.

8. A method of forming electrode material for a lithium secondary cell as recited in claim 1 in which the elemental metal particles are deposited on the particles of nonmetallic electrode material by depositing particles of a compound of the metal compound on the particles of the electrode material, oxidizing the deposited particles to form particles of metal oxide, and chemically reducing the metal oxide particles to elemental metal particles.

9. A method of forming electrode material for a lithium secondary cell as recited in claim 1 in which the elemental metal particles are deposited on the particles of nonmetallic electrode material by forming a chelation complex of the metal compound on the surfaces of the particles of electrode material and chemically reducing the metal compound to deposit particles of the metal from the chelation complex onto the surfaces of the particles of the non-metallic electrode material.

10. A method of forming an anode or cathode electrode material as recited in claim 1 in which the metal particle-coated electrode material particles are deposited by use of an atmospheric plasma onto a porous polymeric or ceramic separator layer.

11. A method of forming an anode or cathode electrode material as recited in claim 1 in which the metal particle-coated electrode material particles are deposited by use of an atmospheric plasma onto a metallic current collector layer.

12. A method of forming electrode material for a lithium secondary cell comprising:
providing particles of lithium titanate as anode electrode material for a lithium secondary cell, the particles of lithium titanate having largest dimensions in the range of about one to about fifty micrometers;
forming a predetermined weight of particles of an elemental metal on the surfaces of the lithium titanate anode material by applying a compound of the metal on the surfaces of the lithium titanate particles and chemically reducing the metal compound to particles of the elemental metal; and, thereafter
inserting the metal particle-coated lithium titanate particles into an atmospheric plasma stream to direct and deposit the metal particle-coated lithium titanate anode material particles in a continuous layer on a cell substrate layer which is a structural member of a lithium secondary cell, the substrate layer being a porous separator layer or a metallic current collector layer, the thickness of the deposited layer of particles being up to about 200 micrometers and the temperature produced in the deposited particles by the atmospheric plasma causing sufficient momentary melting of the metal particles to provide metal coating sites on the surfaces of the lithium titanate particles that bond the lithium titanate particles of the deposited anode layer to each other and to the substrate layer in a porous layer of anode material, the metal coating sites also providing electrical conductivity in the deposited layer of porous anode material.

13. A method of forming electrode material for a lithium secondary cell as recited in claim 12 in which the elemental metal deposited on the lithium titanate particles is selected from the group consisting of copper, gold, nickel, and tin.

14. A method of forming electrode material as recited in claim 12 in which the weight of the elemental metal particles formed on the surfaces of the lithium titanate particles is greater than about five weight percent of the total weight of the particles of lithium titanate and the deposited elemental metal particles.

15. A method of forming an electrode material as recited in claim 12 in which the weight of the elemental metal particles formed on the surfaces of the lithium titanate particles is in the range of from about five weight percent to about sixty weight percent of the total weight of the lithium titanate particles and the deposited elemental metal particles.

16. A method of forming electrode material for a lithium secondary cell as recited in claim 12 in which the elemental metal particles are deposited on the particles of lithium titanate by depositing particles of a compound of the metal compound on the particles of lithium titanate, oxidizing the deposited particles to form particles of metal oxide, and chemically reducing the metal oxide particles to elemental metal particles.

17. A method of forming electrode material for a lithium secondary cell as recited in claim 12 in which the elemental metal particles are deposited on the particles of lithium titanate by forming a chelation complex of the metal compound on the surfaces of the particles of the lithium titanate and chemically reducing the metal compound to deposit particles of the metal from the chelation complex onto the surfaces of the lithium titanate particles.

18. A method of forming electrode material for a lithium secondary cell comprising:
providing particles of a lithium-metal element-oxide (LMO) compound as cathode electrode material for a lithium secondary cell, the metal element (M) being selected from the group consisting of cobalt, manganese, and nickel, the particles of the LMO compound having largest dimensions in the range of about one to about fifty micrometers;
forming a predetermined weight of particles of an elemental metal on the surfaces of the LMO compound particles by applying a compound of the metal on the surfaces of the LMO compound particles and chemically reducing the metal compound to particles of the elemental metal; and, thereafter
inserting the metal particle-coated LMO compound particles into an atmospheric plasma stream to direct and deposit the metal particle-coated LMO compound cathode material particles in a continuous layer on a cell substrate layer which is a structural member of a lithium secondary cell, the substrate layer being a porous separator layer or a metallic current collector layer, the thickness of the deposited layer of particles being up to about 200 micrometers and the temperature produced in the deposited particles by the atmospheric plasma causing sufficient momentary melting of the metal particles to provide metal coating sites on the surfaces of the LMO compound particles that bond the LMO compound particles of the deposited cathode layer to each other and to the substrate layer in a porous layer of cathode material, the metal coating sites also providing electrical conductivity in the deposited layer of porous anode material.

19. A method of forming electrode material for a lithium secondary cell as recited in claim 18 in which the elemental metal deposited on the LMO compound particles is selected from the group consisting of aluminum, copper, gold, nickel, and titanium.

20. A method of forming electrode material as recited in claim 18 in which the weight of the elemental metal particles formed on the surfaces of the LMO compound particles is greater than about five weight percent of the total weight of the particles of LMO and the deposited elemental metal particles.
